(19) United States
(12) Patent Application Publication
(10) Pub. No.: US 2006/0272912 A1
(43) Pub. Date: Dec. 7, 2006

(54) Cable vibration control with a TMD-MR damper system

(76) Inventor: Chunsheng Cai, Baton Rouge, LA (US)

Correspondence Address: PATENT DEPARTMENT;TAYLOR, PORTER, BROOKS & PHILLIPS, L.L.P, P.O. BOX 2471, BATON ROUGE, LA, 70821-2471, US

(21) Appl. No.: 11/385,485

(22) Filed: Mar. 20, 2006

Related U.S. Application Data
(60) Provisional application No. 60/663,646, filed on Mar. 21, 2005.

(51) Int. Cl. F16F 7/10

(52) U.S. Cl. 188/380

(57) ABSTRACT

An apparatus and method to enhance the overall performance of vibration dampers by adjusting the damping and stiffness in the damper for flexible members (e.g., stay cables, cable-stayed bridges, suspension bridges, power lines, and signal posts) experiencing excessive fluctuating vibration in any direction is disclosed. In a preferred embodiment, the apparatus comprises a second structural member, first structural member, springs, and one or more magnetorheological (MR) damper. The second structural member anchors the flexible member and transfers vibration energy to the variable damper(s) and first structural member. The springs provide elastic stiffness for the damper. The MR damper(s) allows for the controllably adjustable, absorption and dissipation of vibration energy in the flexible member by adjusting the damping and stiffening in the damper to a level such that the vibration frequency of the first structural member is about the same as that of the flexible member.

The development of this invention was funded in part by the Government under grant number NCHRP-92 awarded by the National Research Council.

This invention pertains to an apparatus and method of enhancing the overall performance of vibration dampers in flexible members (e.g., stay cables, cable-stayed bridges, suspension bridges, power lines, and signal posts) by adjusting the damping and stiffness of the damper for flexible members experiencing excessive vibrations in any direction.

Cable-stayed bridges have become one of the most efficient and cost-effective structures for bridge spans ranging between 500 ft and 1500 ft. With its worldwide popularity, longer spans are being constructed employing increasingly longer stay cables that have low fundamental frequency and inherent damping. One of the most common causes of problems in cable-stayed bridges is a phenomenon known as wind-rain-induced cable vibration, which involves large-amplitude vibrations (about 1 m to about 2 m) of stay cables experiencing combinations of light rain and moderate wind speeds of about 10 m/s to about 15 m/s. Wind-rain-induced cable vibration has been reported worldwide as one of the most damaging vibration phenomena in cable-stayed bridges. This phenomenon may induce structural fatigue and damage the cable or cable connections at the bridge deck and tower. See Y. Hikami, “Rain vibrations of cables in cable-stayed bridges,” Journal of Wind Engineering, 27, 17-28 (in Japanese) (1986); M. Matsumoto, et al. “Rain-wind induced vibration of cables of cable-stayed bridges,” J. Wind Engineering and Industrial Aerodynamics, 44, pp. 2011-2022 (1992); H. Tabatabai, et al., “Tuned dampers and cable fillers for suppression of bridge stay cable vibrations,” Final report to TRB DEA program (Construction Technology Laboratories, Inc, Skokie, Ill., 1999); and J. A. Main, et al., “Evaluation of Viscous Dampers for Stay-cable vibration mitigation,” Journal of Bridge Engineering, ASCE, 6(6), 385-397 (2001).

Studies have shown that the main cause of wind-rain-induced vibrations is the formation of water rivulets along the upper windward surface of the cable and its interaction/formation of wind flow in the near wake of the cables. The formed water rivulets change the aerodynamic shape of the cable and thus affect the cable's aerodynamic performance. In the last few years, research has been very active in developing methods of reducing wind-rain-induced cable vibration using various techniques.

One technique for overcoming wind-rain-induced cable vibration involves the use of mechanical dampers (e.g., oil dampers and friction dampers) to reduce cable vibration. While mechanical dampers can be useful for short cables by connecting one end of the damper to the deck and the other end to the cable, the vibration reduction effects are not optimal for long cables because mechanical dampers are usually installed close to the cable anchorages to suppress vibrations. For a more efficient vibration reduction, the damper should be connected from the deck to a point more close to the mid-span of the cable, which is not practical for long cables. TMDs can overcome this restriction and they were experimentally investigated and recommended for cable vibration reduction. However, this recommendation was based on the observed damping effect of TMD dampers on the free vibration of a cable in the first mode. It has been found that the wind-rain cable vibrations are often related to higher mode vibrations. Therefore, a TMD designed for the first mode vibration is most likely not effective for higher mode vibrations because the TMD effectiveness is frequency/mode sensitive. See H. Tabatabai, et al., 1999.

Another method of reducing wind-rain-induced cable vibration is to increase the in-plane stiffness and frequency of the stay-cables by reducing the free length of the cables using cross-ties (i.e., transverse secondary cables), which connect the cables together, which is esthetically unappealing. Meanwhile, the cross-ties may be broken due to the vibrations.

A third method involves modifying the cable surface using techniques such as double helix spiral bead formations to improve its aerodynamic properties. This method is not applicable for cables of existing bridges. It will also increase the wind load on cables and results in other types of cable vibration problems, such as vortex shedding induced vibrations. See M. Matsumoto, et al., “Response characteristics of rain-wind induced vibration of stay-cables of cable-stayed bridges,” J. Wind Engineering and Industrial Aerodynamics, 57, pp. 323-333 (1995); O. Flamand, “Rain-wind induced vibration of cables,” Journal of Wind Engineering and Industrial Aerodynamics, 57, pp. 353-362 (1995); and R. S. Phelan, et al., “Investigation of Wind-Rain-Induced Cable-Stay Vibrations on Cable-Stayed Bridges,” Final Report, (Center for Multidisciplinary Research in Transportation, Texas Tech University, Lubbock, Tex., 2002).

H. Tabatabai, et al., “Tuned Dampers and Cable Fillers for Suppression of Bridge Stay Cable Vibrations,” Final Report to TRB IDEA program (Construction Technology Laboratories, Inc, Skokie, Ill., 1999) discloses the use of tuned mass dampers (TMDs) for suppression of bridge stay cable vibrations. TMDs were observed to be more efficient in damping out free vibration than other countermeasures (e.g., a liquid damper, and a cable wrapped with damping tape, and a cable guide-pipe filled with polyurethane material). Although the study proved TMDs could be used for effectively suppressing bridge stay cable vibrations when the excitation is a narrow-band vibration or the cable vibration derives from one mode, when the excitation is wide-band vibration or the cable vibration derives from several modes, the vibration reduction effect is reduced.

Because the natural frequencies between preset TMDs and cables may be offset for various reasons (e.g., unpredicted nonlinearity of actual cables, the difference between calculation models and prototype cables, and the time-dependent attribute of the cable force), it is often difficult to achieve optimal vibration reduction effects in field applications.

Z. Q. Chen, et al., “MR damping system on Dongting Lake cable-stayed bridge,” Smart Systems and Nondestructive Evaluation for Civil Infrastructures, pp. 229-235 (San Diego, Calif., USA, 2003) discloses the use of magnetorheological (MR) dampers to control wind-rain-induced cable vibration. Although MR dampers were able to reduce vibration on a cable-stayed bridge, the dampers had to be grounded to the deck, near the lower-end of the stay cable (a distance from the cable end of approximately 0.02-0.05 the cable length) for installation and operation. This results in the MR damper not being able to effectively control three dimensional cable vibrations.

A need exists for an apparatus and method of enhancing the overall performance of vibration dampers in flexible members (e.g., stay cables, cable-stayed bridges, suspension bridges, power lines, and signal posts) by adjusting the damping and stiffness of the damper for flexible members experiencing excessive vibrations in any direction.

I have discovered an apparatus and method to enhance the overall performance of vibration dampers by adjusting the damping and stiffness of the dampers for flexible members experiencing excessive vibrations in any direction. Compared to other devices and methods that enhance the overall performance of vibration dampers, the novel apparatus and method allows for variable, rapidly controllable, adaptive excitation field control for optimal damping, placing anywhere along a flexible member to directly absorb vibration energy in either symmetric and anti-symmetric modes and provide damping against vibration in one or more directions. The apparatus comprises a first structural member, second structural member, and one or more variable damper assemblies. The second structural member anchors the flexible member and transfers vibration energy to the variable damper(s) and first structural member. The second structural member can be any size and materials as long as the damper can be secured on the flexible member. The first structural member is about 1 to 5% the weight of the flexible member. The variable damper(s) allows for the controllably adjustable damping and stiffness, absorption and dissipation of vibration energy in the flexible member such that the vibration frequency of the first structural member is about the same as that of the flexible member.

In a preferred embodiment, the variable damper is a magnetorheological (“MR”) damper, which allows for an adjustable damping, such that the stiffness and damping of the damper is adjusted to balance the vibration frequency of the flexible member with that of the first structural member. In this embodiment, a vibration frequency monitor (e.g., an accelerometer) is placed between the first and second structural members to measure the vibration frequency of the flexible member. (The vibration frequency monitor can be attached to the second member to monitor the vibration frequency emanating from the flexible member.) If the vibration frequency monitor detects a vibration frequency in the flexible member, which is different from that of the first structural member, the amount of current sent to the MR damper(s) is increased or decreased to balance the vibration frequency of the flexible member with that of the first structural member by adjusting the magnetic field produced in the MR damper.

### BRIEF DESCRIPTION OF THE DRAWINGS

FIG. 1A is a graph plotting the damping force of one embodiment of the MR damper as a function of time at various currents.

FIG. 1B is a graph plotting the damping force of one embodiment of the MR damper as a function of displacement at various currents.

FIG. 1C is a graph plotting the damping force of one embodiment of the MR damper as a function of velocity at various currents.

FIG. 1D is a graph plotting the velocity of one embodiment of the MR damper as a function of displacement at various currents.

FIG. 2 is a graph plotting the peak output damping force of one embodiment of the MR damper as a function of current.

FIG. 3A is a graph plotting the damping force of one embodiment of the MR damper as a function of displacement at a current level of 0 A with various frequencies.

FIG. 3B is a graph plotting the damping force of one embodiment of the MR damper as a function of displacement at a current level of 0.20 A with various frequencies.

FIG. 3C is a graph plotting the damping force -of one embodiment of the MR damper as a function of displacement at a current level of 0.40 A with various frequencies.

FIG. 4A is a graph plotting the damping force of one embodiment of the MR damper as a function of velocity at a current level of 0 A with various frequencies.

FIG. 4B is a graph plotting the damping force of one embodiment of the MR damper as a function of velocity at a current level of 0.20 A with various frequencies.

FIG. 4C is a graph plotting the damping force of one embodiment of the MR damper as a function of velocity at a current level of 0.40 A with various frequencies.

FIG. 5A is a graph plotting the displacement of one embodiment of the MR damper as a function of time with various loading waves.

FIG. 5B is a graph plotting the velocity of one embodiment of the MR damper as a function of time with various loading waves.

FIG. 5C is a graph plotting the damping force of one embodiment of the MR damper as a function of displacement with various loading waves.

FIG. 5D is a graph plotting the damping force of one embodiment of the MR damper as a function of velocity with various loading waves.

FIG. 5E is a graph plotting the velocity of one embodiment of the MR damper as a function of displacement with various loading waves.

FIG. 6A is a graph plotting the damping force of one embodiment of the MR damper as a function of displacement at a current level of 0 A with various temperatures.

FIG. 6B is a graph plotting the damping force of one embodiment of the MR damper as a function of displacement at a current level of 0.20 A with various temperatures.

FIG. 6C is a graph plotting the damping force of one embodiment of the MR damper as a function of displacement at a current level of 0.40 A with various temperatures.

FIG. 7A is a graph plotting the damping force of one embodiment of the MR damper as a function of velocity at a current level of 0 A with various temperatures.

FIG. 7B is a graph plotting the damping force of one embodiment of the MR damper as a function of velocity at a current level of 0.2 A with various temperatures.

FIG. 7C is a graph plotting the damping force of one embodiment of the MR damper as a function of velocity at a current level of 0.4 A with various temperatures.

FIG. 8 is a schematic diagram of a model cable system.

FIG. 9 is a graph plotting the natural frequencies of a stay cable as a function of tension force in the cable.

FIG. 10A is a graph plotting the acceleration response of a stay cable as a function of time at a current level of 0 A.

FIG. 10B is a graph plotting the acceleration response of a stay cable as a function of time at a current level of 0.1 A.

FIG. 10C is a graph comparing the acceleration response of a stay cable as a function of time at a current level of 0.1 A and 0.2 A.

FIG. 11 is a graph comparing the acceleration response of a stay cable under forced vibration as a function of time.

FIG. 12A is a graph comparing the acceleration response of a stay cable as a function of current at various frequencies.

FIG. 12B is a graph comparing the acceleration response of a stay cable as a function of frequency at various currents.

FIG. 13 is a schematic diagram of a two-mass system.

FIG. 14A is a schematic diagram of one embodiment of a TMD-MR system.

FIG. 14B is a side plane view of the housing of one embodiment of the MR damper.

FIG. 14C is a side plane view of the piston of one embodiment of the MR damper.

FIG. 15 is a graph plotting the acceleration response of a stay cable as a function of time at various currents.

FIG. 16 is a graph plotting the acceleration response of one embodiment of the TMD-MR damper as a function of time at various currents.

FIG. 17A is a graph plotting the power spectral density of a stay cable as a function of frequency at various currents.

FIG. 17B is a graph plotting the power spectral density of one embodiment of a TMD-MR damper as a function of frequency at various currents.

FIG. 18A is a graph plotting the power spectral density of a stay cable as a function of frequency at various tension forces.

FIG. 18B is a graph plotting the power spectral density of one embodiment of a TMD-MR damper as a function of frequency at various tension forces.

FIG. 19A is a graph plotting the maximum acceleration of a stay cable as a function of vibration at various frequncy levels.

FIG. 19B is a graph plotting the maximum acceleration of one embodiment of the TMD-MR system as a function of vibration at various frequency levels.

The general purpose of this invention is to enhance the overall performance of vibration dampers in flexible members (e.g., stay cables, cable-stayed bridges, suspension bridges, power lines, and signal posts) experiencing excessive fluctuating vibration. More specifically, the purpose of this invention is to provide an apparatus and method of allowing for the variable, rapidly controllable, adaptive excitation field control for optimal damping anywhere along a flexible member to directly absorb vibration energy occurring in one or more directions. The apparatus comprises a first structural member, second structural member, and one or more variable damper assemblies. The second structural member anchors the flexible member and transfers vibration energy to the variable damper(s) and first structural member. The variable damper(s) allows for the absorption and dissipation of vibration energy in the flexible member by adjusting the damping and stiffening of the damper to a level such that the vibration frequency of the first structural member is about the same as that of the flexible member. In situations involving an anti-symmetric vibration mode, the apparatus should be placed at or near the peaks of the vibration curve. In an alternative situation involving symmetric vibration, the apparatus should be placed at or near the middle of the vibration curve. It is essential that the variable damper be capable of eliminating mechanical viscosity control components by utilizing active working fluids having viscous properties that change under the influence of electric or magnetic fields.

A preferred active working fluid is Magnetorheological (MR), more preferably MRF-336G MR fluid (Silicone-based Rheonetic™M; Lord Corporation, Cary, N.C.) which was used to practice this invention. MR is preferred because it has the unique ability to change properties when electric or magnetic fields are applied. This change mainly is manifested as a substantial increase in the dynamic yield stress, or apparent viscosity, of the fluid. MR has an operating temperature range of from −40° C. to 150° C. and requires activation voltages of less than 100 volts. MR fluids provide robust, rapid response interfaces between electronics, controls, and mechanical systems in real time. See, e.g, U.S. Pat. No. 6,694,856.

There are several advantages to using this device to reduce resonant vibration in flexible members. First, the number of components may be minimal. Fabrication may be simple and inexpensive. Second, the apparatus allows for the adjusting of the natural frequency of a damper system to match a targeted resonant excitation frequency. Third, the apparatus allows for simultaneous damping of a flexible member experiencing different excitations. The device can dissipate energy directly from a flexible member by providing continuously adjustable damping and stiffness when the flexible member experiences multiple dominating vibration modes.

### EXAMPLE 1

To understand the dynamic characteristics of a cable system employing the novel TMD-MR dampers, an investigation of individual MR damper, pure cable dynamic properties, cable dynamic properties with a TMD, and cable dynamic properties with a MR damper was conducted. A scaled-down prototype TMD-MR damper was fabricated and the dynamic characteristics of the cable system were measured with the prototype TMD-MR damper placed on the cable.

Investigation of Individual MR Dampers

Two models of MR dampers (RD-1005-3 and RD-1097-01; Lord Corporation Corporation, Cary, N.C.) were tested to obtain their performance curves before they were used to reduce cable vibration. Some relative parameters provided by Lord Corporation are listed in Table 1. Experiments on the RD-1097-01 MR damper are presented in detail because its output damping force is more suitable for the present cable application than RD-1005-3.

TABLE 1

| | RD-1005-3 | RD-1097-01 |
|---|---|---|
| Maximum Extension (mm) | 53 | 58 |
| Body Diameter (mm) | 41 | 32 |
| Weight (N) | 8 | 5 |
| Electrical Characteristics: | | |
| Input Current (continuous) | 1 amps maximum | 0.5 amps maximum |
| Input Current (intermittent) | 2 amps maximum | 1.0 amps maximum |
| Damper Force: | | |
| 2 in/sec at 1 amp | >2224 N | >98 N |
| 8 in/sec at 0 amp | <667 N | <9 N |

A Universal Test Machine (UTM) 5P (Boronia Victoria, Australia) having a maximum output force of 5 kN was used to investigate the two dampers. The two dampers were tested vertically using a displacement control method and amplitudes of 10 mm or 5 mm. The force and displacement time series data were read by a Photon data acquisition system (Dactron Incorporated, Milpitas, California) every 0.01 sec or 0.02 sec. (The experiments stopped automatically after 20 cycles.) The velocity of the MR damper was obtained from the displacement with a forward-difference approximation. An ampere meter and a Wonder Box controller (Lord Corporation, Cary, N.C.) were connected in series with the MR damper to measure and adjust the current in the MR damper. Different experimental parameters were considered, including working temperatures, loading wave types, loading frequencies, and currents provided to the MR dampers.

MR Damper Performance with Different Currents

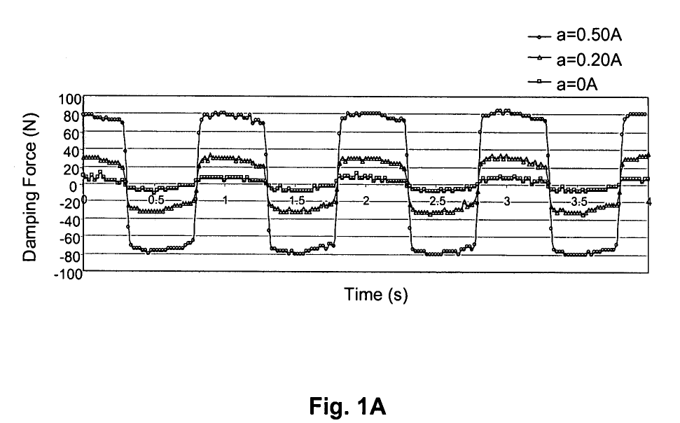

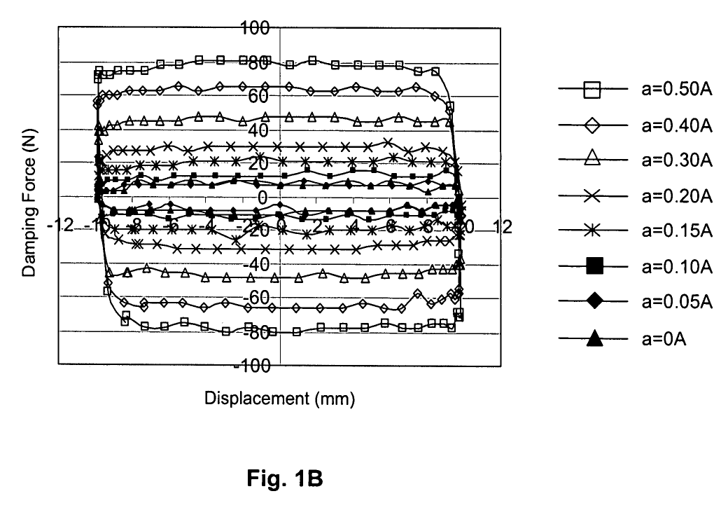

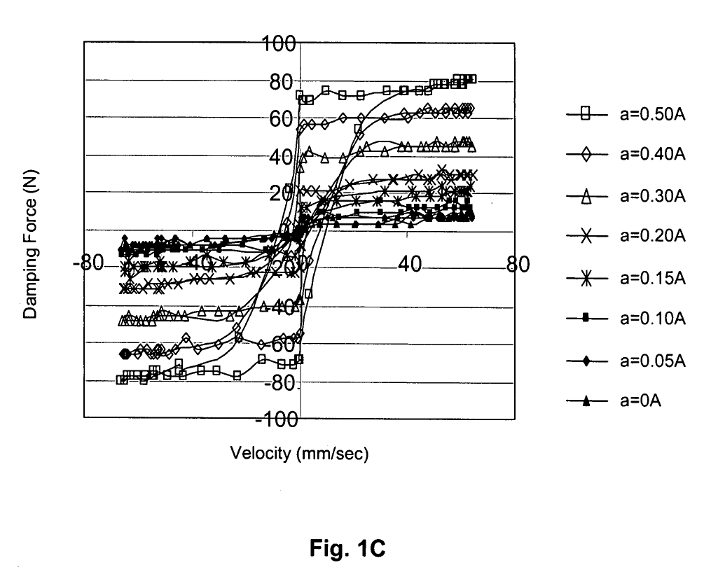

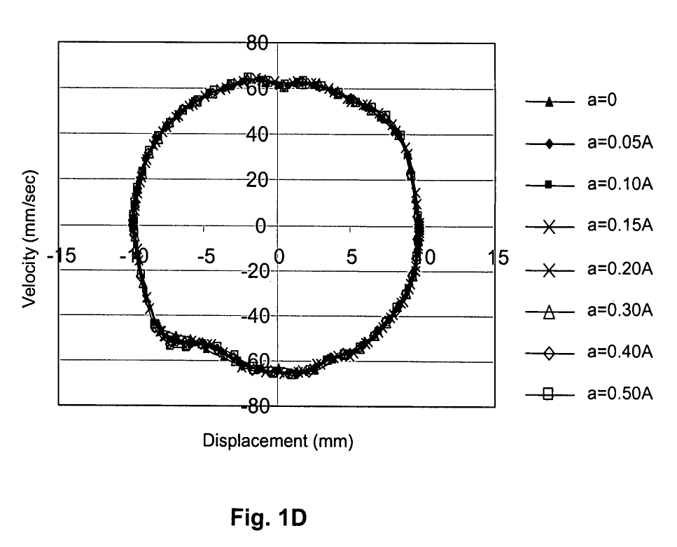

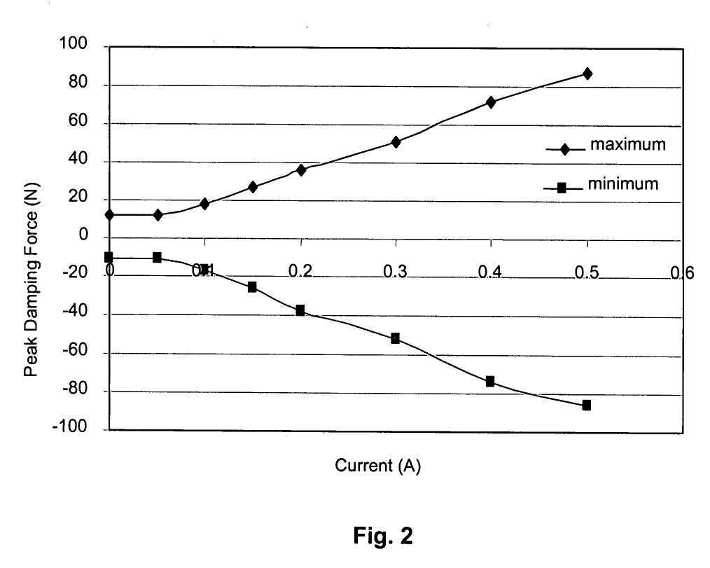

FIGS. 1A, 1B, and 1C are graphs plotting the maximum output damping force at various frequencies as a function of time, displacement and velocity, respectively. Effects of electric currents on the damper performance were determined using eight current levels (e.g., 0 A, 0.05 A, 0.1 A, 0.15 A, 0.2 A, 0.3 A, 0.4 A, and 0.5 A) under a sine-loading wave with a constant loading frequency of 1 Hz, amplitude of 10 mm, and an experiment temperature of 20° C. The maximum output damping force, as shown in FIG. 1A, was about 10 N with a current of 0 A (passive mode of the MR damper), and about 80 N when the current increased to 0.50 A. Thus, the ratio between the peak output damping force at the maximum current to the damping force at the passive mode (dynamic range of the MR damper) was 8. The curve of displacement versus output damping force, as shown in FIG. 1B, is rectangularly-shaped. The larger displacement-force curve loop dissipates more energy because the area of the loop represents the energy dissipated in each cycle. Thus, with a larger current, the MR damper can dissipate more energy for each cycle. According to FIG. 1B, the curve of the velocity versus the output damping force can be estimated using linear functions. The relationship curve between the displacement and velocity, as shown in FIG. 1D, is elliptical. The relationship between the maximum output damping force and the current input is shown in FIG. 2.

MR Damper Performance with Different Frequencies

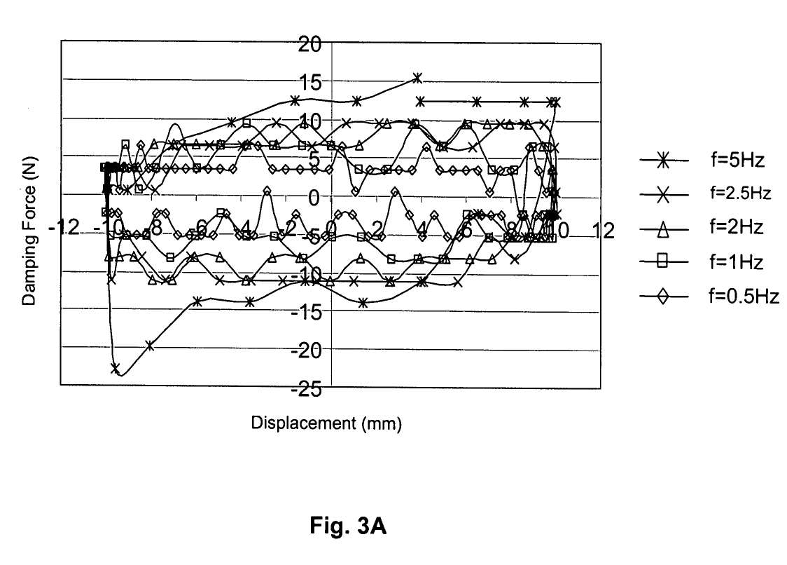

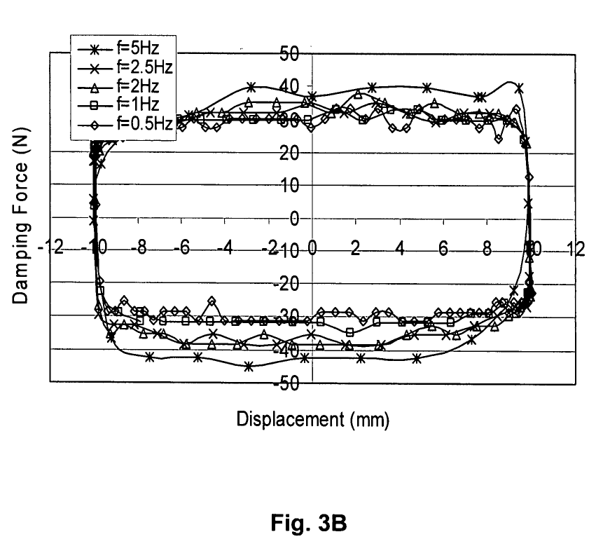

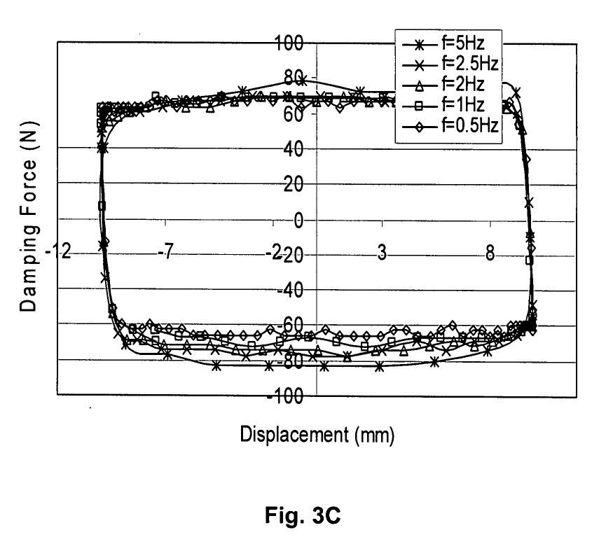

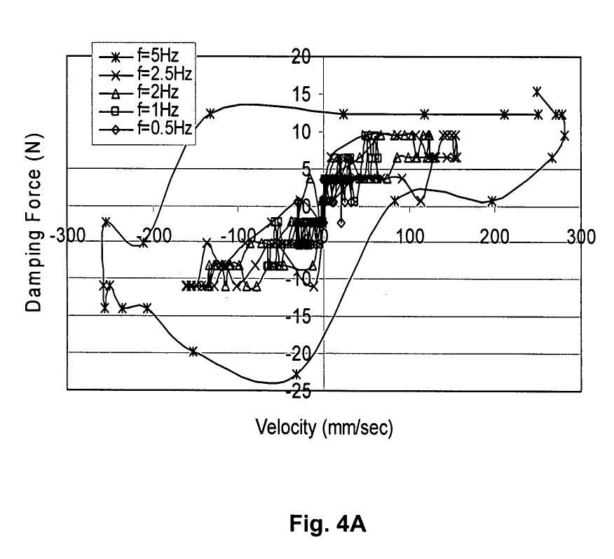

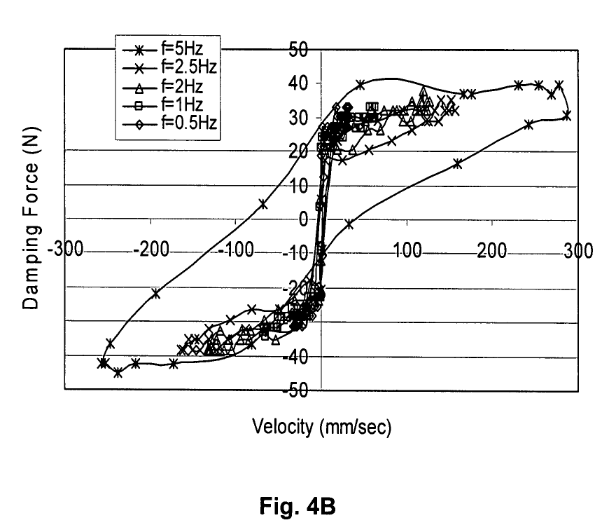

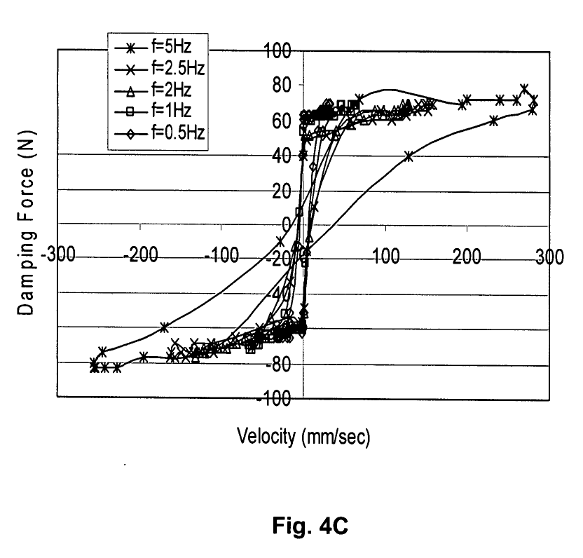

FIGS. 3A, 3B, and 3C are graphs plotting the damping force at various frequencies as a function of displacement at a constant current of 0 A, 0.20A, and 0.40A, respectively. Five loading frequencies (e.g., 0.5 Hz, 1 Hz, 2 Hz, 2.5 Hz and 5 Hz) were used to measure the effects of the loading frequencies on the MR damper performance. (All the other parameters remained the same as in the previous section; in the figures, “D” means displacement, “F” means output damping force, and “V” means velocity.) As shown in FIGS. 3A-3C, the effect of loading frequency on the output damping force-displacement relationship decreased as the current increased. However, as shown in FIGS. 4A-4C, the damping force-velocity relationship was more sensitive to the loading frequency.

MR Damper Performance with Different Loading Waves

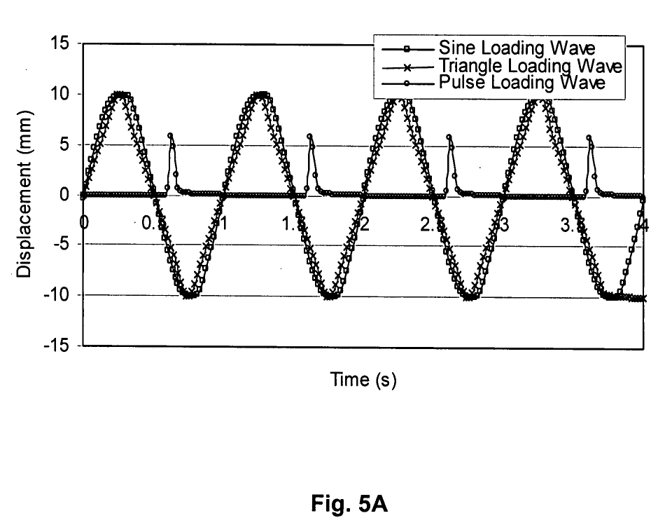

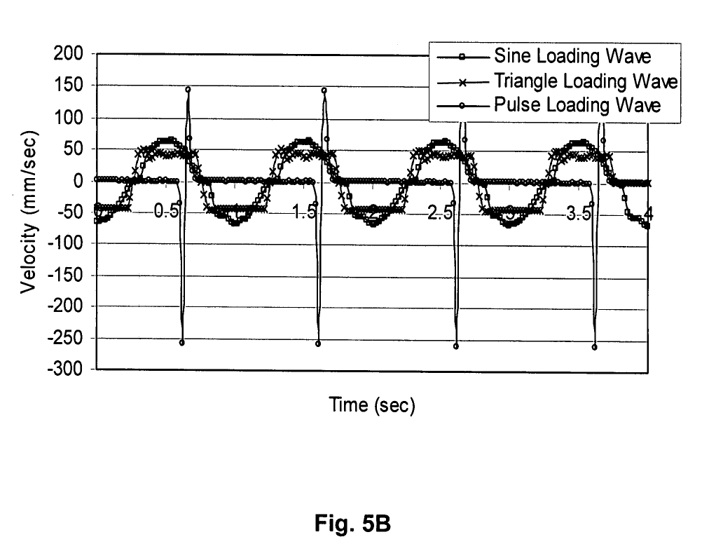

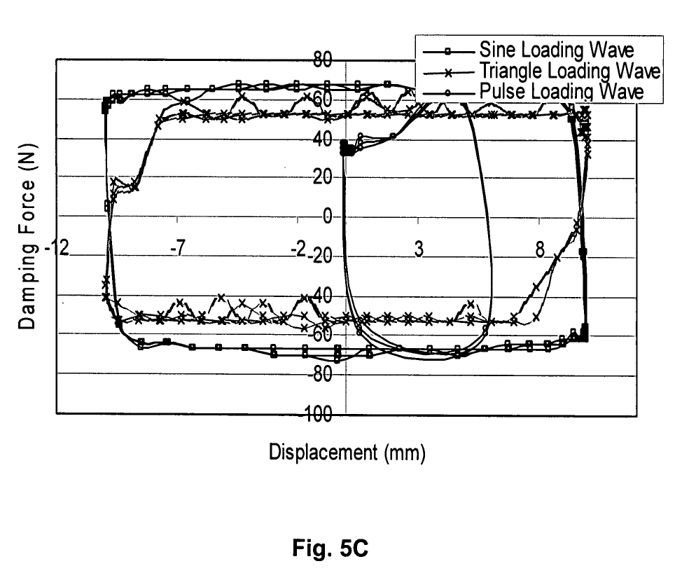

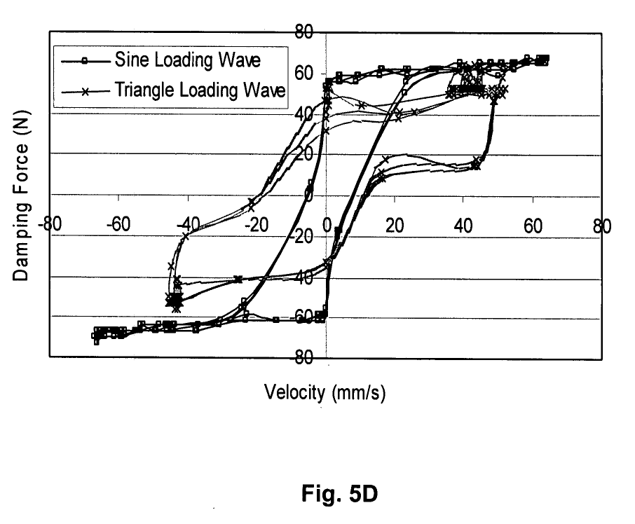

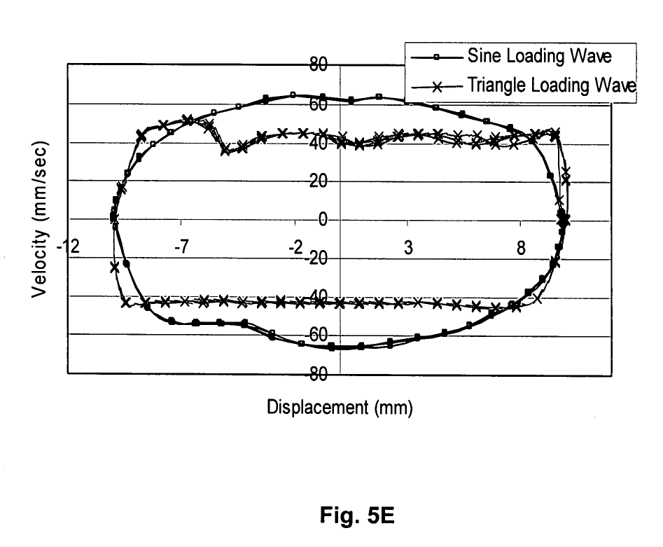

FIGS. 5A-5E are graphs plotting the effects of different simulated loading waves on the MR damper performance at a current of 0.4 A and a loading frequency of 1 Hz. FIG. 5A depicts a graph plotting displacement as a function of time at three different loading waves (e.g., sine, triangle and pulse waves). FIG. 5B depicts a graph plotting velocity as a function of time. The corresponding output damping force of the triangle-loading wave, as shown in FIG. 5B, was less than that of the sine-loading wave. For the pulse-loading wave, the output damping force was also in the form of a pulse wave. FIG. 5C depicts a graph plotting damping as a function of displacement. In the case of the pulse-loading wave, the displacement-force curve was a curved quadrangle that was much smaller than the rectangular curves of the sine and triangle loading cases. Because the peak velocity of the pulse-loading wave was much larger than the other two cases, the corresponding curve of the pulse-loading wave was not plotted in FIG. 5D and 5E. As shown in FIG. 5D and 5E, the velocity-force curve of the sine-loading wave was flatter than that of the triangle-loading wave. The ellipse displacement-velocity curve loop for the sine-loading wave was larger than that of the triangle-loading wave, meaning that the former dissipate more energy.

MR Damper Performance with Different Temperatures

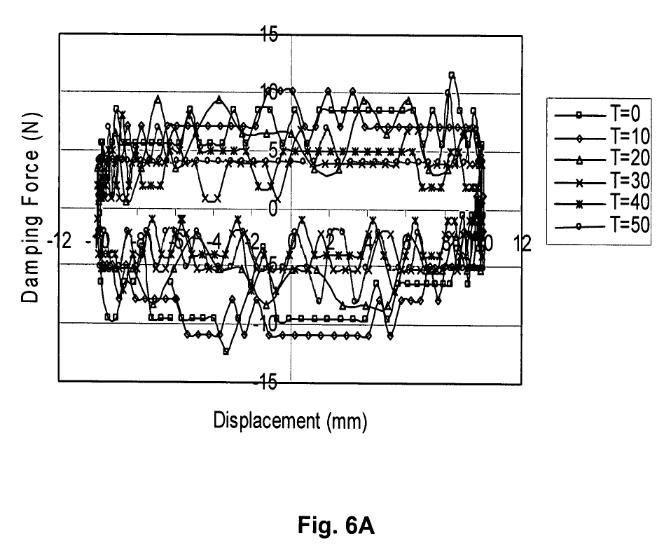

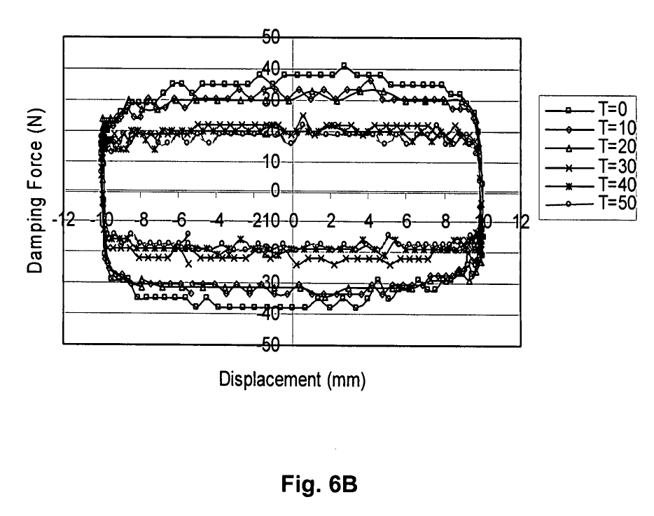

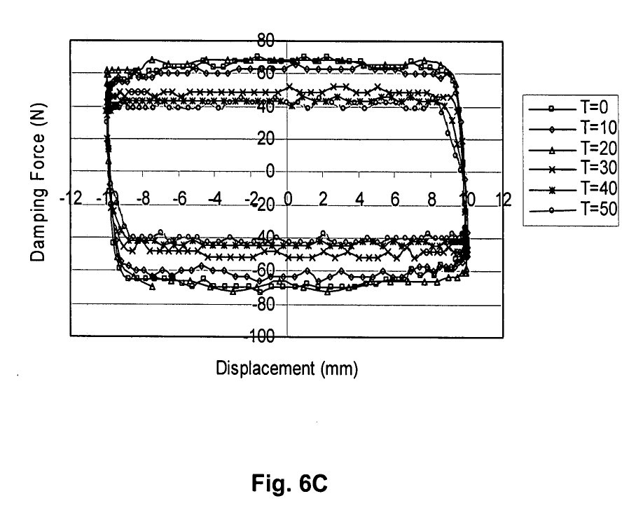

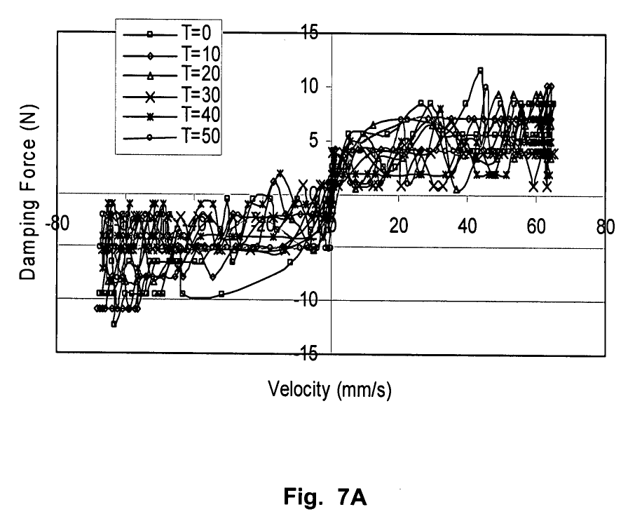

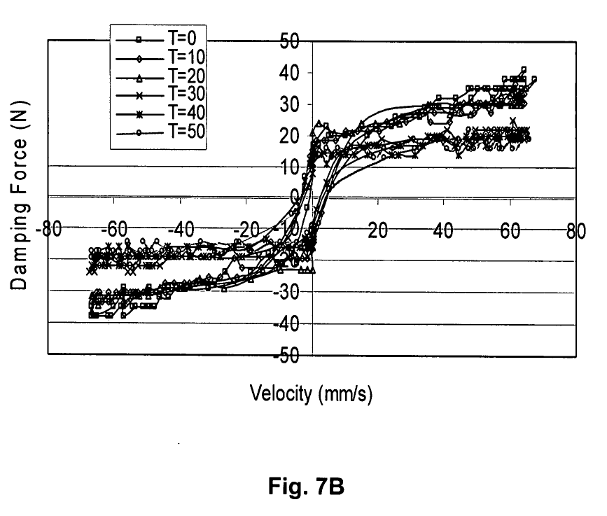

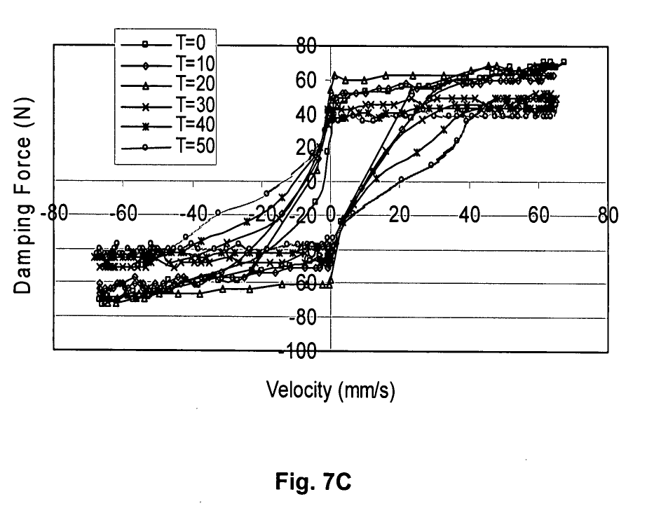

FIGS. 6A-6C are graphs plotting the damping effects of the MR damper (at-various working temperatures) as a function of displacement at currents of 0 A, 0.2 A, and 0.4 A, respectively. The experimental temperatures were 0° C., 10° C., 20° C., 30° C., 40° C. and 50° C. The currents and frequencies were varied as in the previous tests. Only the sine-loading wave was investigated. The results indicate that temperature does affect the performance curve of the MR damper. As temperature increases, the output damping force decreases nonlinearly. As shown in FIGS. 6A-6C, the damping force-displacement curves of 0° C., 10° C. and 20° C., and 30° C., 40° C. and 50° C. cluster into two separate groups. Similar observations can be made from the velocity-force curves as shown in FIGS. 7A-7C.

### EXAMPLE 2

### Cable Vibration Control with MR Dampers

Scaling Theory for Model Cable

The scaling factor for velocity between the prototype and the model cables was 1 and the length dimension was 8. Based on these two scaling factors, scaling factors for other associated parameters can be calculated by physical relationships. Table 2 provides the model cable parameters used in the present experimental studies. Parameters for the corresponding prototype cable were calculated using Tables 2 and 3.

TABLE 2

| | | | | | |
|---|---|---|---|---|---|
| Frame Distance (l) | 7.0 | m | Frame Height (h) | 1.40 | m |
| Cable Length (L) | 7.16 | m | Cable Angle (α) | 11.27° | |
| Cable Area (A) | 98.7 | mm² | Axial Stress (σ) | 162.7 | Mpa |
| Cable Number (N) | 1 | | Axial Force (T)* | 16064.5 | N |

*These parameters may change according to different experiments.

TABLE 3

| | Scaling factor |
|---|---|
| Parameter | (model/prototype) |
| Dimension | 1/n |
| Area | 1/n² |
| Volume | 1/n³ |
| Young's Modulus | 1 |
| Material Strength | 1 |
| Density | 1 |
| Poisson's Ratio | 1 |
| Damping Ratio | 1 |
| Spring Constant | 1/n |
| Mass | 1/n³ |
| Signal Frequency | n |
| Dynamic Time | 1/n |
| Displacement | 1/n |
| Velocity | 1 |
| Acceleration | n |
| Stress | 1 |
| Strain | 1 |
| Force | 1/n² |
| Energy | 1/n³ |

(Tabatabai, et al., 1999)

Test Setup and Equipments

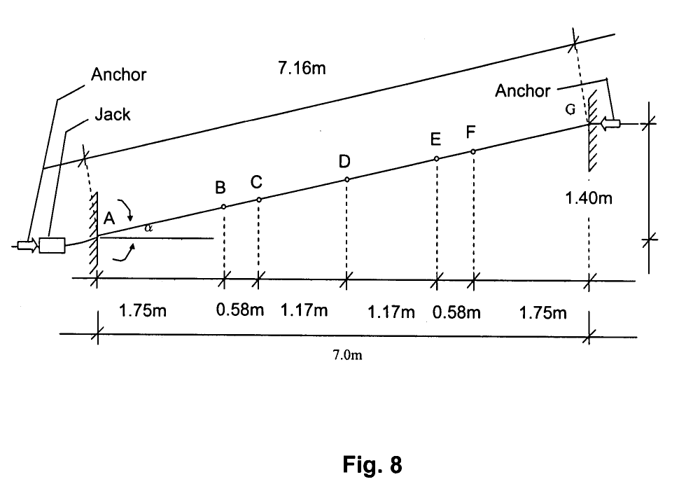

FIG. 8 is a schematic diagram of a model cable system. The stay-cable was made of one strand steel comprising seven wires having a cross section of 98.7 mm². Both ends of the cable were anchored to the frame at different heights. Because the lower end of the cable extends through a hydraulic jack before being anchored, an adjustable tension force may be placed on the cable. Nine tension forces were chosen to measure the vibration control effect of the added MR damper under different tension forces. The geometric relation of points B, C, D, E, and F is shown in FIG. 8. These points are installation positions for external vibration loadings, the damping device and measuring sensors, and are located as follows: Point D is the middle point, B and F are ¼ span length points, and C and E are ⅓ span length points of the cable.

A vibrator (V408; Ling Dynamic Systems Ltd, Yalesville, Conn.) and amplifier (PA100E CE, Ling Dynanic Systems Ltd, Yalesville, Conn.) were used to generate and amplify the forced vibration. An Enerpac hydraulic jack (Milwaukee, Wis.) was used to provide axial tension force. An accelerometer (model 352C22; PCB Piezotronics Inc., Depew, New York) and signal conditioner (model 480B21; PCB Piezotronics Inc., Depew, N. Y.) were used to measure and amply the acceleration signals, respectively. A PHOTONS data acquisition (Dactron Incorporated, Milpitas, Calif.) was used to acquire the acceleration signals.

### EXAMPLE 3

### Experimental Results

Frequency Characteristics of Stay Cable

To determine the frequency characteristics of the stay cable, a 93.4 N mass was hung at point ‘D’ to give the stay cable a free vibration. The acceleration time histories at points ‘B’ and ‘D’ were measured by two accelerometers and collected by a Photons data acquisition system. Fast Fourier Transformation (FFT) of those time history data was carried out to form the frequency spectra. From the frequency spectra, the basic natural frequency of the cable without damper was 8.93 Hz at a cable axial tension force of 16.06 KN. Because the scaling factor used is 8, the frequency of the prototype should correspondingly be 1.12 Hz, which is within the reasonable range of the actual cable frequency. (Tabatabai, et al. 1999.) Theoretically, the cable natural frequency can be calculated by the following equations:

$$\begin{matrix}tan ( Ω / 2 ) = Ω / 2 - ( 4.0 / {λ}^{2} ) {( Ω / 2 )}^{3} & ( 1 ) \\ Ω = 2 π fL / \sqrt{T / m} & ( 2 ) \\ {λ}^{2} = {( \frac{mg L cos ( α )}{T} )}^{2} L / \frac{{TL}_{e}}{EA} & ( 3 ) \\ {L}_{e} = ( 1 + \frac{{( \frac{mg L cos ( α )}{T} )}^{2}}{8} ) L & ( 4 )\end{matrix}$$

in which, E is the Young's modulus, T is the tension force, L is the cable length, α is the inclined angle, Lₑ is the deformed cable length (Assumed as a parabolic deflected shape), A is the cross section area, m is the mass per unit length, and λ² is proportional to the ratio of the axial stiffness to the geometric stiffness. It is a non-dimensional parameter to describe the cable dynamic behavior. See H. M. Irvine, “Cable Structure,” (MIT Press Series in Structural Mechanics, Cambridge, Mass., and London, England, 1981).

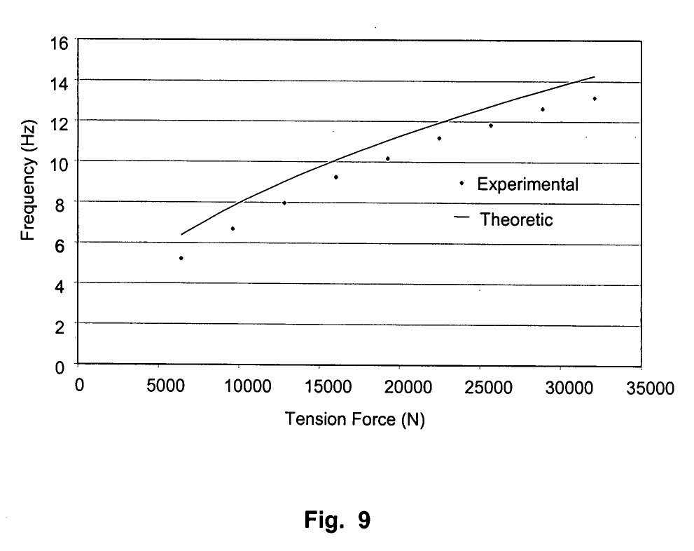

From Eqs. (1)-(4), the frequency f can be calculated as 10.08 Hz, which is 12.9 % higher than the experimental result. If the tension force is changed, the natural frequency of the cable will also change. The theoretical and experimental frequencies versus tension forces are shown in FIG. 9.

Free Vibration

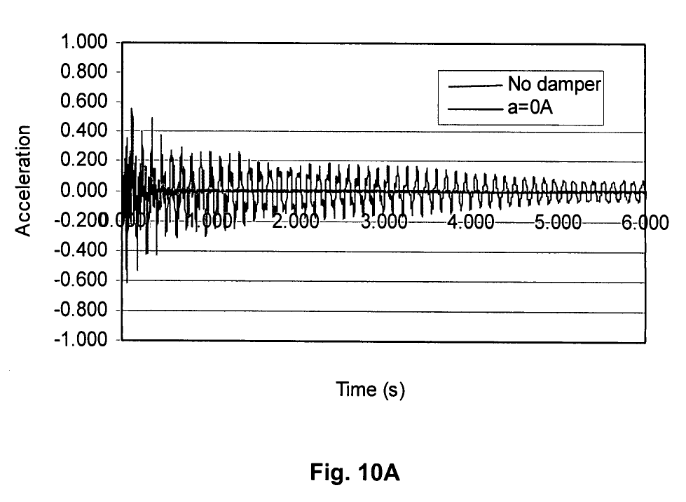

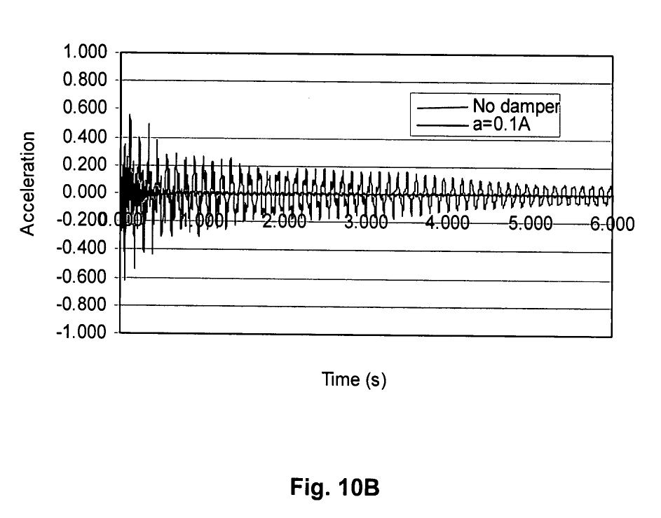

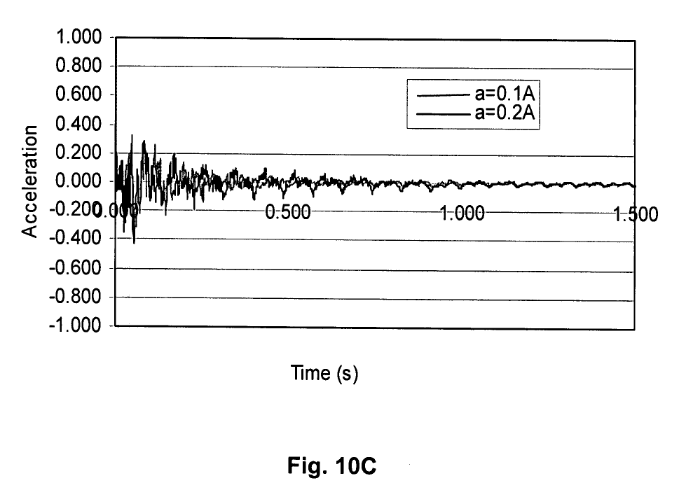

FIGS. 10A-10C are graphs plotting the acceleration of the cable with an MR damper as a function of time at various currents. To determine acceleration responses of the stay cable in free vibration, the MR damper was connected to point ‘B’ to reduce the cable vibration. As shown in FIG. 10A, at a current of 0 A the MR damper reduced the cable vibration efficiently. When the current reached 0.1 A, the acceleration response, as shown in FIG. 10B, was reduced more quickly than the acceleration response at a current of 0 A. FIG. 10C shows the acceleration time history data with currents of 0.1 A and 0.2 A from 0 sec to 1.5 sec. The MR damper with a current of 0.2 A reduced the vibration, as shown in FIG. 10C, slightly more efficient than the MR damper with a current of 0.1 A at the beginning when vibration was large. The vibration reduction was almost the same after 0.5 sec because when the measured vibrations signals are small, the relative error due to the noise is larger. Because the MR damper can be considered as a Bingham element, it needs a larger force (or vibration) to overcome the Coulomb friction to pull and push the damper when the current becomes larger. If the driving force provided by the cable vibration is not enough, the MR damper will work as a fixed support (or locked). Thus, the damping effect under different currents beyond a critical current will not differ much.

Forced Vibration

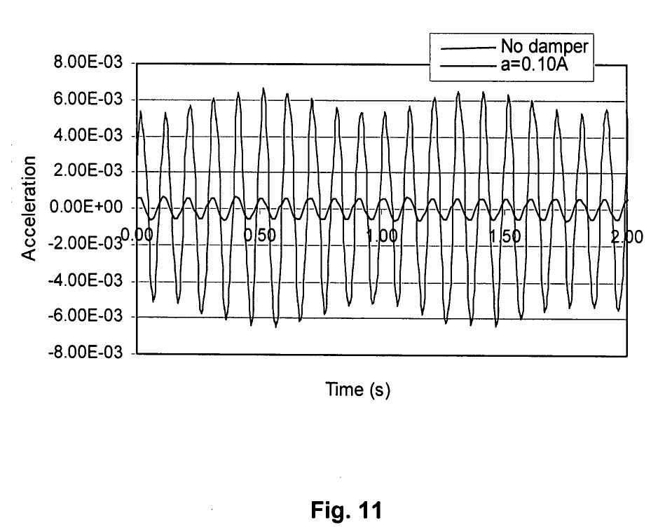

To determine acceleration responses in forced vibration, a shaker (vibrator) (model V408; Ling Dynamic Systems Ltd, Yalesville, Conn.) working as an excitation source was positioned 0.18 m away from the low end of the stay cable (2.3 % of the cable length). As shown in FIG. 11, the stable cable vibration with a damper of 0.1 A current was much less than that without damper with a 10 Hz sine wave excitation. The ratio of the peak value between the study with damper at 0.1 A current and no damper was about 14.

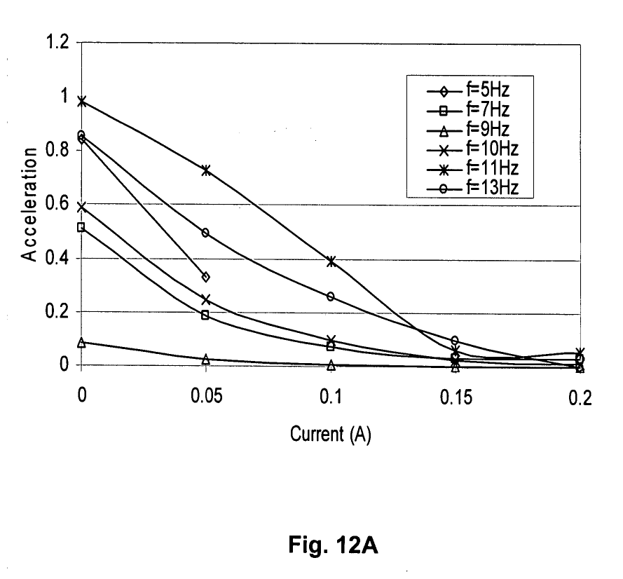

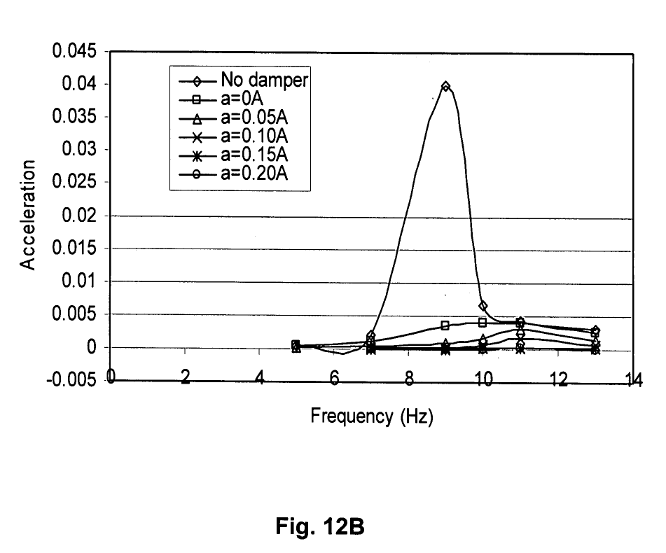

FIGS. 12A and 12B are graphs plotting acceleration responses as a function of current with various frequencies and as a function of frequency with various currents, respectively. For each excitation frequency, the acceleration was normalized, as shown in FIG. 12A, with the peak acceleration when no damper was used. Thus, the effect of reduction is much better at an excitation of 9 Hz, which corresponds to the resonant frequency of the cable system. When the excitation frequency was away from the resonant frequency, the reduction efficiency decreased correspondingly. When the current is increased, the resonance frequency increased slightly, as shown in FIG. 12B. Thus, the stiffness of the damper increased with the damper current such that the natural frequency of the cable-damper system increased.

### EXAMPLE 3

### Cable Vibration Control with TMD-MR Dampers

Concept and Principle of TMD-MR Damper

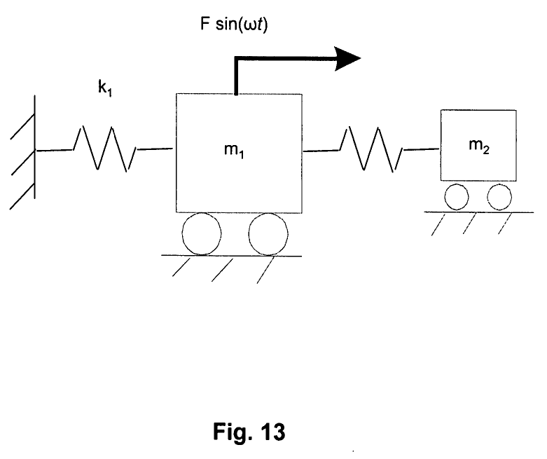

TMDs have been studied extensively in structural vibration control. The concept of vibration control by TMDs can be stated as follows: the interaction between any two elastic bodies can be represented by a two-mass system shown in FIG. 13. Under the excitation of a sinusoidal force, Fsin(ωt), acting on mass 1, the vibration amplitudes of this two-mass system are derived as,

$${X}_{1} = \frac{{Fm}_{2} ( {ω}_{{m}_{2}}^{2} - {ω}^{2} )}{( {k}_{1} + {k}_{2} - {m}_{1} {ω}^{2} ) ( {k}_{2} - {m}_{2} {ω}^{2} ) - {k}_{2}^{2}} , \\ {X}_{2} = \frac{{Fm}_{2} {ω}_{{m}_{2}}^{2}}{( {k}_{1} + {k}_{2} - {m}_{1} {ω}^{2} ) ( {k}_{2} - {m}_{2} {ω}^{2} ) - {k}_{2}^{2}} \qquad ( 5 )$$

where ωₘ_{ᵢ}²=k₁/m₁ and ωₘ_{₂}²32 k₂/m₂. It can be seen from Eq. (5) that when ωₘ_{₂}²=ω², when vibration amplitude of mass 1 vanishes with X₁=0 and the amplitude of mass 2 is X₂=F/k₂.

The basic concept of cable vibration control using the novel apparatus is similar to the two degrees of freedom system as shown in FIG. 13, where the cable mass and the mass of TMD-MR system are represented by m₁ and m₂, respectively.

Prototype TMD-MR damping System

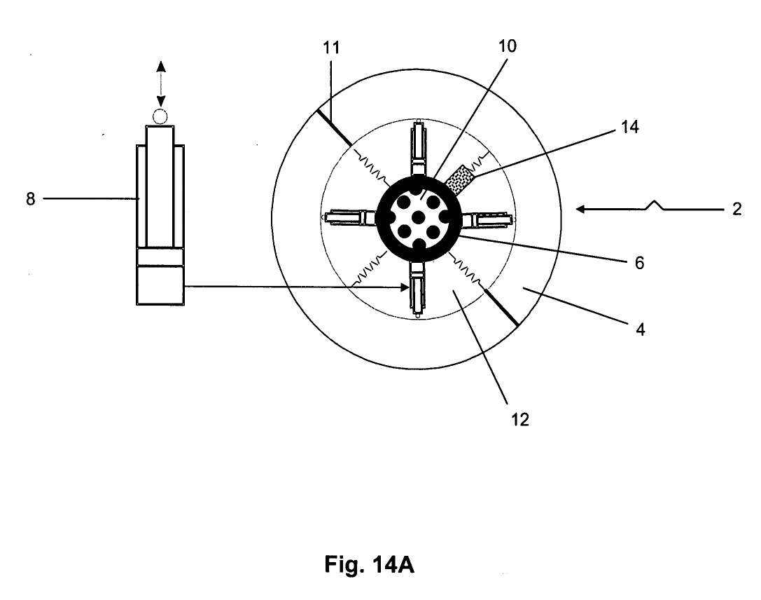

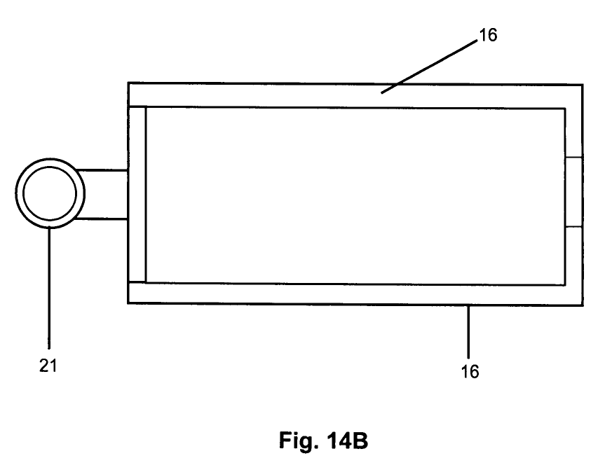

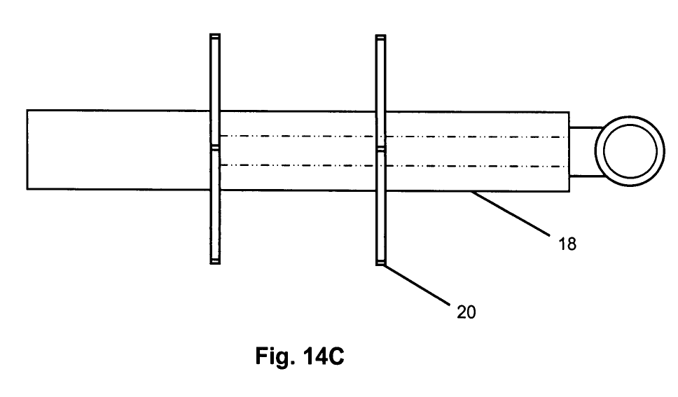

FIG. 14 is a schematic diagram of one embodiment of the novel damping system 2. In this embodiment, the novel apparatus comprises a tuned mass damper having a first structural member 4, second structural member 6, and one or more variable damper assemblies 8. Second structural member 6 was adapted to anchor flexible member (stay cable) 10 and variable damper 8 to first structural member 4, and to transfer vibration energy from flexible member 10 to variable damper 8 and first structural member 4. Second structural member 6 may be made from a material capable of being securely fastened around cable 10 such as steel, aluminum, copper, and stainless steel.

As shown in FIG. 14, first structural member 4 and variable dampers 8 form a weighted member system adapted to absorb and dissipate vibration energy transferred from stay cable 10. In a preferred embodiment, first structural member 4 is made of steel and has a weight equal to between one percent and five percent the entire weight of cable 10. (In cases involving the use of more than one TMD-MR damper system, e.g., a stay cable having a length of 100 m-500 m, the weight of total number of first structural members 6 is equal to between one percent and five percent the entire weight of the cable.) Second structural member 6 anchors cable 10 and transfers vibration energy to variable dampers 8 and first structural member 4. First structural member 4 contained two slits 11 adapted to allow for the separation and placement of first structural member 4 around cable 10.

As shown in FIG. 14, variable dampers 8 are adapted to allow for the controllably adjustable, absorption and dissipation of vibration energy in cable 10 by adjusting the damping and stiffening of dampers 8 to a level such that the vibration frequency of first structural member 4 is about the same as that of cable 10. In a preferred embodiment, variable dampers 8 are a magnetorheological (MR) damper, as more fully described by Lord Corporation (1999) “Engineering Note for Designing with MR Fluids” found at http://iiterature.lord.com/root/other/rheonetic/designing_with_MR_fluids.pdf comprising a housing 16 for containing a volume of MR fluid, a piston 18 adapted for movement within housing 16, piston 18 being formed of ferrous metal, having a number, N, of windings of conductive wire incorporated therein to define one are more coils 20 that produce magnetic flux in and around piston 18. See FIGS. 14B and 14C. Housing 16 may be provided with a sleeve of ferrous material to increase the cross-sectional area of the return flow path (not shown) for the magnetic flux. Piston 18 may be formed from conventional ferrous materials (in either solid or laminate form) or from powdered metals. See FIG. 14C. Optionally, the novel apparatus further comprises one or more springs 12 adapted to complement variable dampers 8 such that the combined vibration frequency of first structural member 4 and springs 12, which together form a tuned mass damper 2, is similar to that of cable 10. A device capable of detecting and measuring acceleration in stay cable 10 caused by vibration such as an accelerometer 14 (model 352C22; PCB Piezotronics Inc., Depew, N.Y.) may also be placed between second structural member 6 and first structural member 4 to measure the vibration frequency of cable 10.

In this embodiment, the frequency of TMD-MR system 2 was tuned to the frequency corresponding to the highest peak resonant vibration or other targeted frequency, along with the adjustment of its location and damping ratio, in order to optimally suppress the vibration. This was achieved by monitoring vibration frequency in cable 10 using accelerometer 14. When a vibration frequency exceeding that of first structural member 4 was detected, the amount of current sent to variable dampers 8 was increased to balance the vibration frequency of cable 10 with that of first structural member 4 by increasing the magnetic field and friction produced in variable dampers 8. (While adjustment of the current was accomplished manually, it may be achieved automatically using certain software and hardware known in the art.) This increases the effective damping and stiffness produced by variable dampers 8. Alternatively, when accelerometer 14 detected a vibration frequency in cable 10, which was less than that of first structural member 4, the amount of current sent to variable dampers 8 was decreased to balance the vibration frequency of cable 10 with that of first structural member 4 by decreasing the magnetic field and friction produced in variable dampers 8 such that the stiffness of variable dampers 8 decreased and the effective damping increased.

Construction of the TMD-MR Damper Prototype

The variable dampers 8 used to test the design of the prototype was based on the MR damper design more filly described by Lord Corporation (1999) comprising a housing 16 for containing a volume of MR fluid, a sleeve for attachment housing 16 to second structural member 6, a piston 18 adapted for movement within housing 16, piston 18 being formed of ferrous metal, having a plurality of windings of conductive wire incorporated therein to define two coils 20 that produce magnetic flux in and around piston 18. The assumed design parameters of the MR dampers 8 are listed in Table 4. Housing 16 was 50 mm long and 4 mm thick. Housing 16 had a 6 mm bore for passage of piston 18. Sleeve 21 had an inner diameter of 4 mm and an outer diameter of 6 mm. Piston 18 was 50 mm long and had a diameter of 6 mm. A pin 22 having an inner diameter of 4 mm and an outer diameter of 6 mm was used to attach piston 18 to first structural member 4. Coils 20 had a diameter of 15.2 mm. The magnetic field intensity of coils 20 was 175 kAmp/m with 90 amp-tums. (Consequently, if the maximum current provided to the MR damper is 0.5 A, then the turn number can be determined as 180.)

TABLE 4

| Parameter | Value | | Parameter | Value | |
|---|---|---|---|---|---|
| Maximum force | ˜50 | N | Minimum force | ˜5 | N |
| Dynamic range | 10 | | Outer Diameter (dₗ) | 20 | mm |
| Yield Stress | 45000 | pa | Viscosity | 4˜8 | pa · s |
| Magnetic induction | 0.75 | T | Cable frequency | 1˜10 | Hz |

Testing of Prototype TMD-MR Damping System

To confirm that the prototype TMD-MR damping system was effective, trials were conducted on a stay cable. The TMD-MR damper was installed on a stay cable having a tension force of 16.06 kN. The parameters of the cable-TMD-MR damper system are listed in Table 5. Because adding the MR damper would affect the natural frequency of the TMD-MR damper system, the frequency of the TMD damper was designed at about 7 Hz, which is less than the cable natural frequency of 8.93 Hz. (This was obtained from previous experiments as described in Example 1, using a tension force of 16.06 kN.) One accelerometer was placed on the cable and a second on the first structural member 4 of the TMD-MR damper so that the acceleration of both the cable and the TMD-MR damper could be measured. The unit of the measured acceleration was electronic signal volts. Two baffles were installed on the cable to prevent out-of-plane vibration of the TMD-MR damper.

TABLE 5
TMD-MR Damper

| | Upper Spring | Lower Spring |
|---|---|---|
| Mass | Stiffness | Stiffness |
| 0.3175 Kg | 304.5 N/m | 481.25 N/m |

Cable-TMD-MR System

| TMD-MR Location | Frequency Ratio | Mass Ratio |
|---|---|---|
| Middle of the cable | 1.27 | 0.06 |
| or point “D” in | | |

Parameters Variation Range

| | Current in MR | Control |
|---|---|---|
| Tension (kN) | damper | Experiments |
| 12.85-32.13 | 0˜0.20A | No damper, TMD only |

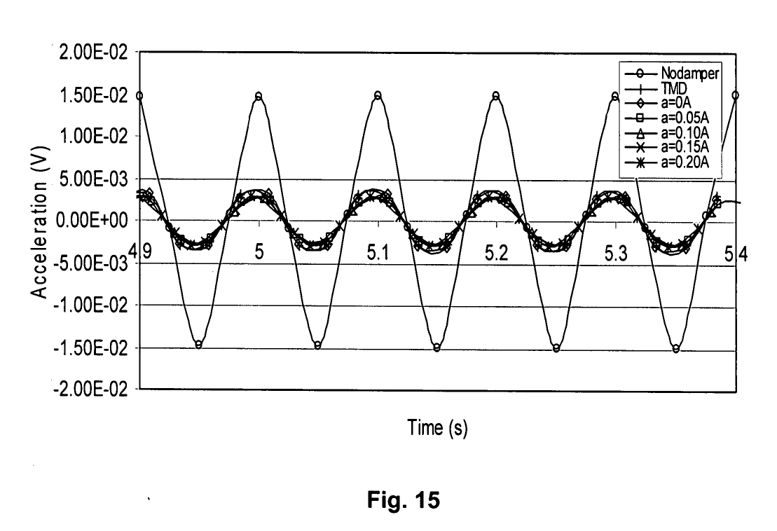

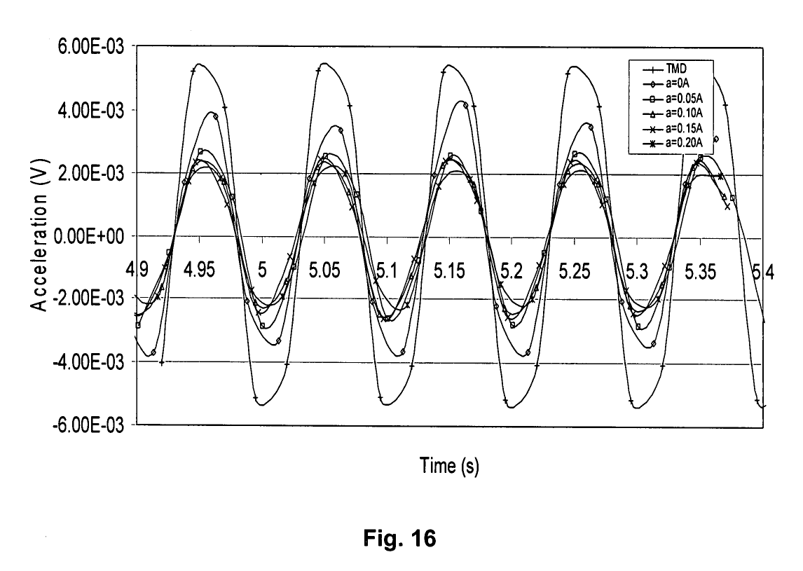

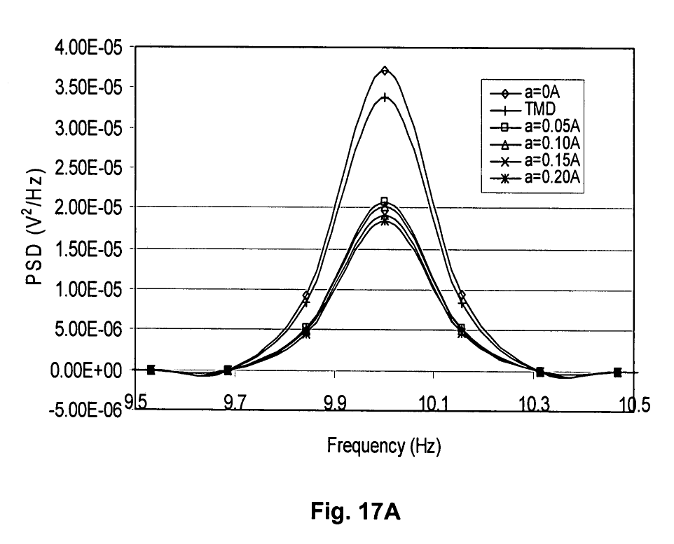

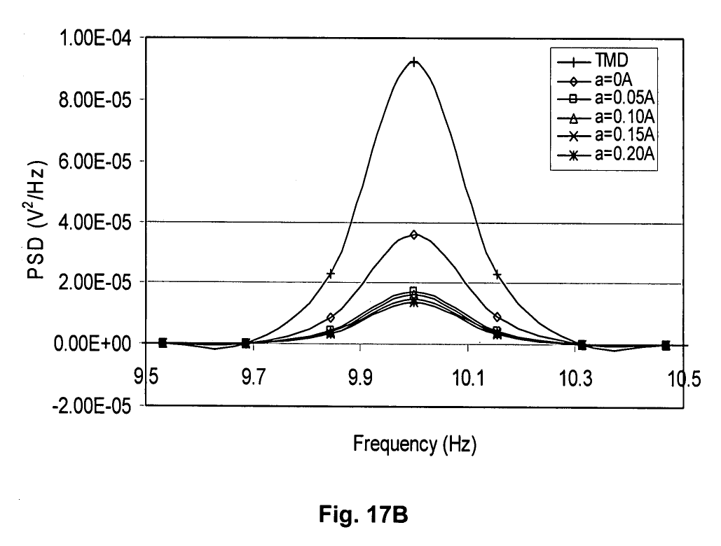

FIG. 15 is a graph plotting acceleration of the cable as a function of time at various currents. When there was no damper attached onto the cable, the vibration was the largest. When the TMD or TMD-MR damper was attached onto the cable, the cable vibration was reduced to different levels based on the amount of current supplied to the MR damper. From FIG. 16 and Table 6, it was determined that the TMD-MR damper reduced the cable vibration down to about 20% from the power spectral density (PSD) perspective. (There was some saturation effect because the reduction effects were similar at 0.15 A and 0.2 A.) As shown in FIGS. 17 A and 17B, as the current inside the MR damper increased, the vibration decreased for both the cable and the TMD-MR damper. Thus, the existence of the MR damper also helped reduce the TMD vibration. The reduction effect of pure TMD was between that of the TMD-MR damper with 0 A current and 0.05 A. As shown in FIG. 17B, the TMD damper vibrated the largest in the case of cable with TMD (no MR damper component). Thus, the cable vibration was transferred to the TMD vibration.

TABLE 6

| | Case | | | | | |
|---|---|---|---|---|---|---|
| | TMD only | 0 A | 0.05 A | 0.10 A | 0.15 A | 0.20 A |
| Effect | 27.1% | 28.2% | 21.3% | 20.8% | 20.2% | 19.7% |

Vibration Energy Transfer

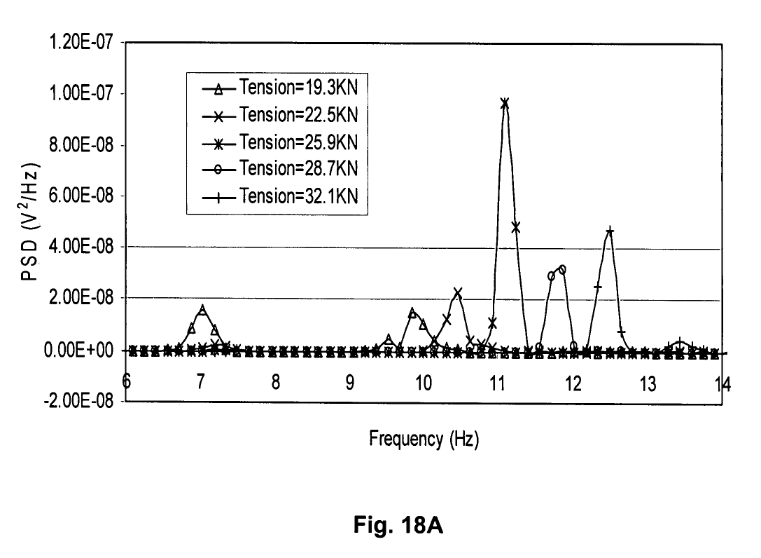

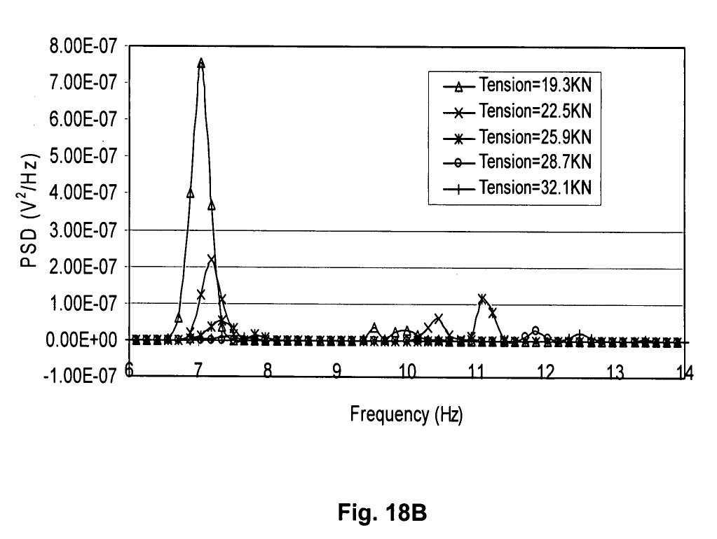

From FIGS. 18A and 18B, it can be observed that there were two PSD peaks for each cable tension force. One peak was related to the natural frequency of the TMD damper and the other was related to the natural frequency of the cable. As the tension force increased, the natural frequencies of both the cable and the TMD damper increased. This means that the measured cable frequency and TMD damper frequency were no longer pure frequencies. The frequency of cable included the influence of the TMD damper and vice verse. As shown in FIG. 18A, the vibration energy at, for example, a cable force of 25.9 kN, mostly centralized around the natural frequency of the cable (˜11.09 Hz). The energy corresponding to the TMD damper natural frequency was small (˜7.0 Hz). However, in FIG. 18B, the vibration energy around the natural frequency of the TMD damper (˜7.0 Hz) dominated and the energy corresponding to the cable natural frequency (˜11.09 Hz) was less. Thus, the vibration energy transferred from the cable to the TMD damper.

Frequency Shift

Adding TMD-MR or TMD affected the natural frequency of the cable. By adding the TMD damper, the frequency of the cable-TMD system was less than that of the pure cable, though the frequency shift was small as shown in Table 7.

TABLE 7

| | | | | | |
|---|---|---|---|---|---|
| Tension (kN) | 19.3 | 22.5 | 25.9 | 28.7 | 32.1 |
| Frequency of pure cable | 10.16 | 10.94 | 11.72 | 12.5 | 13.13 |
| (Hz) | | | | | |
| Frequency of cable-TMD | 9.84 | 10.47 | 11.09 | 11.88 | 12.5 |
| (Hz) | | | | | |

Factors Affecting Vibration Reduction Effect

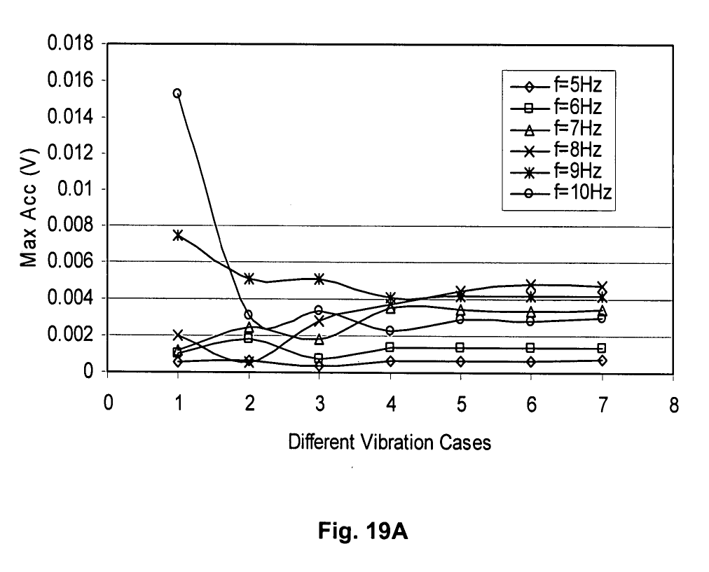

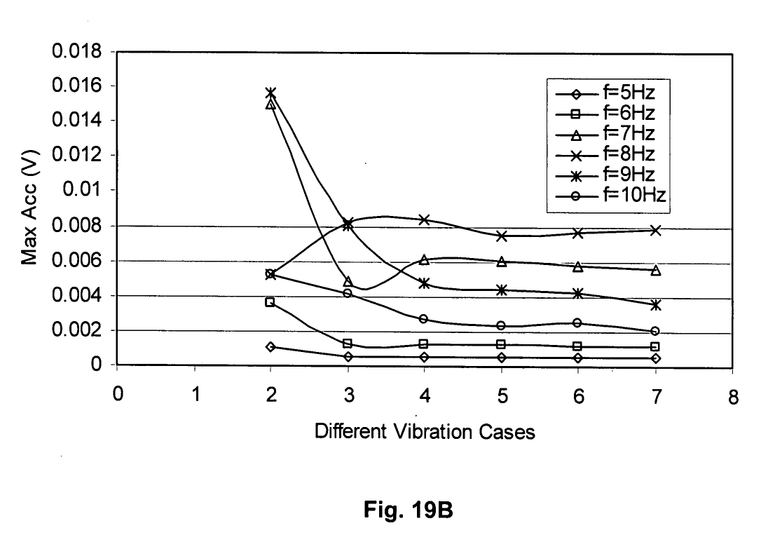

TMD-MR damper improved the cable damping and changed the natural frequency of the cable system. The mass of the TMD-MR damper used in this experimental study was about 6% of the entire cable weight. FIGS. 19A and 19B plots the maximum acceleration of different cable experiments at various frequencies with and without a TMD-MR damper. Table 8 defines the case number shown as the X-axis in FIGS. 19A and 19B and the corresponding experimental setup. After the installation of the MR damper, the. TMD-MR natural frequency was different from that of TMD (7 Hz). When the excitation frequency reached 5 Hz and 6 Hz, which is away from the natural frequency of both the cable (˜9 Hz) and the TMD-MR damper (˜8 Hz), the best vibration reduction occurred in the case of the passive TMD-MR damper (with 0 A current, Vibration Case 3) for both the cable and the TMD-MR vibration. As the current inside the MR damper increased, the cable vibration increased from the 0 A Vibration Case to the 0.05 A Vibration Case, and remained almost the same when the current changed from 0.05 A to 0.20 A. This observation verifies that larger current in the MR damper does not guarantee better vibration control effect for the cable. This phenomenon is due to two reasons. First, when the excitation frequency is away from the cable frequency and the TMD-MR damper frequency, the cable vibration is small so that the control effect of TMD-MR damper is also small. Second, a larger current in the MR damper will increase the natural frequency of the TMD-MR damper so that the stiffness change effect of the TMD-MR damper, which enlarges the cable vibration, is larger than the reduction effect due to its damping increase.

TABLE 8

| | Case Number | | | | | | |
|---|---|---|---|---|---|---|---|
| | 1 | 2 | 3 | 4 | 5 | 6 | 7 |
| Experiment Cases | No damper | TMD only | Passive (a = 0 A) | A = 0.05 A* | a = 0.10 A | a = 0.15 A | a = 0.20 A |

*Meaning that the TMD-MR damper is attached to cable with a current of 0.05A.

When the excitation frequency reaches 7 Hz, which is close to the TMD frequency, a significant vibration was observed in the damper. When the excitation frequency reached 8 Hz, the most noticeable reduction of vibration was in the TMD (without MR damper) (Vibration Case 2). In Vibration Case 2, the cable vibration was reduced to 17% of that of the passive cable-TMD-MR (Vibration Case 3). The TMD damper vibration in Vibration Case 2 was also less than that of Vibration Case 3 because the TMD natural frequency was close to the excitation frequency, and the TMD damper achieved its optimal vibration reduction effect. With this excitation frequency, the cable vibration increased slightly as the MR damper current increased until a current of 0.15 A was reached. The TMD-MR damper vibration level decreased as the current was increased from 0 A to 0.10 A and increased as the current was increased from 0.10 A to 0.20 A.

In all the above cases, the excitation frequency was away from the cable natural frequency such that the cable vibration was not very large even when there was no supplemental damper present. When the excitation frequency reached 9 Hz or 10 Hz, the pure cable vibration was about one to two-orders larger than that with excitation frequency away from the cable natural frequency. The vibration of the cable for the passive TMD-MR damper case (Vibration Case 3) was similar to that of the TMD (without the MR damper) (Vibration Case 2) and smaller than that of the pure cable case without dampers (Vibration Case 1). An increase in the current from 0 A to 0.05 A produced a smaller cable vibration. An increase in the current from 0.05 A to 0.10 A produced a larger cable vibration, while an increase in current from 0.10 A to 0.20 A produced almost a constant cable vibration. By comparing the results of the 9 Hz and 10 Hz cases with those of 5 Hz and 6 Hz, it is observed that the current in the MR damper corresponded to the best reduction effect increase from 0 A to 0.05A and the current corresponding to saturation increases from 0.05 A to 0.10 A. This observation shows that TMD-MR damper is more suitable for reducing large resonant cable vibration that can activate the damper.

Summary and Conclusion

Based on the experimental study, working conditions affect the output damping force of MR dampers to different extents. As the current provided to the MR damper increased, that is as the magnetic field increased, the output damping force increased accordingly. The maximum output damping force is almost a piecewise linear function of the provided current. Loading frequency does not affect significantly the output damping force, especially when the current is relatively high (e.g., 0.15 A). Different loading waves (excitations) affect the output damping force and the shape of the displacement-force curves. Therefore, attention must be paid when the displacement-force curve is used, for example, in a time history analysis.

MR dampers can reduce the cable vibration effectively, regardless of free vibration or forced vibration. A MR damper can provide considerable damping even when it is in its passive mode. The reduction effect of MR dampers increases with the increase of the current especially in resonant and forced vibrations; however, some saturation effect was observed. The damper is most effective for resonant vibrations. When the external loading frequency is away from the resonant frequency or when the vibration is small, the reduction becomes less effective. With the installation of the MR damper, the frequency of the cable-MR system becomes larger than that of the pure cable.

The complete disclosures of all references cited in this specification are hereby incorporated by reference. Also incorporated by reference is the following publication of the inventor's own work: C. S. Cai, et al., “Development of an Adaptive Damper for Cable Vibration Control” IDEA Program Final Report, Contract Number: NCHRP-92 (April, 2005). In the event of an otherwise irreconcilable conflict, however, the present specification shall control.

I claim:

1. A device for enhancing the overall performance of vibration dampers for flexible members experiencing excessive vibrations in any direction by adjusting the damping and stiffness of said vibration dampers; said device comprising:
(a) one or more variable dampers comprising:
(i) a housing having a distal end, a proximal end, and an inner diameter forming a portion of a hollow cavity;
(ii) a piston comprising a proximal end and a distal end having one or more coils for controllably generating a plurality of magnetic fields when energized by a current; wherein said distal end of said piston is slidably received and axially moveable within said hollow cavity through said proximal end of said housing; and wherein said distal end of said piston is adapted to subdivide said hollow cavity into at least a first fluid chamber and a second fluid chamber;
(iii) a passageway formed between said inner diameter of said housing and said piston; and
(iv) an active working fluid contained within said passageway, said first fluid chamber, and said second fluid chamber; wherein when a current is applied to said one or more coils, a plurality of magnetic fields is generated to generate Theological changes which restrict the flow of said active working fluid through said controllable passageway to increase or decrease the friction produced between said piston and housing;
(b) a first structural member; wherein said proximal end of said piston is adapted to be removably attached to said first structural member;
(c) a second structural member for anchoring said flexible member to said distal end of said housing and said first structural member; wherein said second structural member is adapted to transfer vibration frequency from said flexible member to said one or more variable damper and to said first structural member;
(d) a current generator for providing current to said one or more coils; and
(e) a vibration frequency monitor for monitoring vibration frequency in said flexible member;
wherein:
(f) when said vibration frequency monitor detects a peak vibration frequency in said flexible member in any direction that is greater than that of said first structural member, the stiffness and damping of said one or more variable dampers are increased by increasing the magnetic field and friction produced in said one or more variable dampers such that the vibration frequency of said flexible member is balanced with that of said first structural member; and wherein when said vibration frequency monitor detects a peak vibration frequency in said flexible member in any direction that is less than that of said first structural member, the stiffness of said one or more variable dampers is decreased to increase the effective damping of said one or more variable dampers by decreasing the magnetic field and friction produced in said one or more variable dampers such that the vibration frequency of said flexible member is balanced with that of said first structural member.

2. A device as recited in claim 1, wherein said first structural member is about 1 to 5% the weight of said flexible member.

3. A device as recited in claim 1, wherein said vibration frequency monitor is an accelerometer.

4. A device as recited in claim 1, wherein the damping effectiveness of said one or more variable dampers is increased or decreased by manually adjusting the current supplied to said one or more variable dampers.

5. A device as recited in claim 1, wherein the damping effectiveness of said one or more variable dampers is increased or decreased by electronically adjusting the current supplied to said one or more variable dampers.

6. A device as recited in claim 1, wherein said device further comprises one or more springs attached between said first structural member and said second structural member; wherein said one or more springs are adapted to assist said one or more variable dampers in balancing the vibration frequency of said flexible member with that of said first structural member.

7. A device as recited in claim 1, wherein said flexible member is selected from the group consisting of stay cables, cable-stayed bridges, suspension bridges, power lines, and signal posts.

8. A device as recited in claim 1, wherein said active working fluid is magnetorheological fluid.

9. A method for adjusting the vibration frequency in a flexible member experiencing excessive vibrations in any direction, comprising the steps of:
(a) attaching to a flexible member one or more devices comprising one or more variable dampers; a first structural member; a second structural member; a current generator; and a vibration frequency monitor; wherein the vibration frequency of the flexible member are introduced into the one or more devices through the second structural member, which is attached to the flexible member;
(b) monitoring the vibration frequency in the flexible member occurring in any direction;
(c) comparing the vibration frequency in the flexible member to that of the first structural member; and
(d) adjusting the damping and stiffness of the one or more variable dampers to balance the vibration frequency of the flexible member with that of the first structural member by adjusting the current supplied to the one or more variable dampers; wherein when the vibration frequency monitor detects a peak vibration frequency in the flexible member in any direction that is greater than that of the first structural member, the stiffness and damping of the one or more variable dampers are increased by increasing the magnetic field and friction produced in the one or more variable dampers such that the vibration frequency of the flexible member is balanced with that of the first structural member; and wherein when the vibration frequency monitor detects a peak vibration frequency in the flexible member in any direction that is less than that of the first structural member, the stiffness of the one or more variable dampers is decreased to increase the effective damping of the one or more variable dampers by decreasing the magnetic field and friction produced in the one or more variable dampers such that the vibration frequency of the flexible member is balanced with that of the first structural member.

10. A method as recited in claim 9, wherein the first structural member is about 1 to 5% the weight of the flexible member.

11. A method as recited in claim 9, wherein the vibration frequency monitor is an accelerometer.

12. A method as recited in claim 9, wherein the damping effectiveness of the one or more variable dampers is increased or decreased by manually adjusting the current supplied to the one or more variable dampers.

13. A method as recited in claim 9, wherein the damping effectiveness of the one or more variable dampers is increased or decreased by electronically adjusting the current supplied to the one or more variable dampers.

14. A method as recited in claim 9, wherein the device further comprises one or more springs attached between the first structural member and the second structural member; wherein the one or more springs are adapted to assist the one or more variable dampers in balancing the vibration frequency of the flexible member with that of the first structural member.

15. A method as recited in claim 9, wherein the flexible member is selected from the group consisting of stay cables, cable-stayed bridges, suspension bridges, power lines, and signal posts.

16. A method as recited in claim 9, wherein the active working fluid is magnetorheological fluid.
